(19) United States
(12) Patent Application Publication
(10) Pub. No.: US 2008/0210305 A1
(43) Pub. Date: Sep. 4, 2008

(54) Liquified Natural Gas Sump For a Gravity Based Structure

(75) Inventors: Edwin Kolodziej, Tomball, TX (US); John A. Mills, Sugar Land, TX (US); Jennifer C. Adams-Smith, Katy, TX (US)

Correspondence Address: ROTHWELL, FIGG, ERNST & MANBECK, P.C., 1425 K STREET, N.W., SUITE 800, WASHINGTON, DC, 20005, US

(73) Assignee: Aker Kvaerner, Inc., Houston, TX (US)

(21) Appl. No.: 11/575,725

(22) PCT Filed: Sep. 21, 2005
(86) PCT No.: PCT/US05/33517

§ 371 Date: Aug. 20, 2007

Related U.S. Application Data
(60) Provisional application No. 60/611,388, filed on Sep. 21, 2004.

(51) Int. Cl. F17C 13/00; B65D 90/24

(52) U.S. Cl. 137/1; 62/45.1; 137/312

(57) ABSTRACT

A liquefied natural gas (LNG) sump is provided for a gravity based structure (GBS). The sump includes a sump containment structure having a predetermined volume and floor surface area. The volume and floor surface area are selected in order to allow spilled LNG contained within the sump containment structure to vaporize at a predetermined, safe rate. A trough is provided for collecting spilled LNG on the GBS, such as at the processing area and on a jetty, and delivering the spilled LNG to the sump containment structure.

### RELATED APPLICATION DATA

This application claims the benefit pursuant 35 U.S.C. §119 of the filing date of U.S. provisional patent application No. 60/611,388, filed Sep. 21, 2004, the entire contents of which are hereby incorporated by reference.

### BACKGROUND OF THE INVENTION

1. Field of the Invention

The present invention relates generally to sumps and, more particularly, to a liquefied natural gas (LNG) sump for containment of LNG spills on an offshore gravity based structure or other offshore installation.

2. Description of the Related Art

Gravity based structures (GBS) have been used in the design of offshore oil and gas storage facilities for more than 30 years in many parts of the world, predominantly in areas of severe storms for years to design. Due to their strength and reliability, gravity-based structures have been such as the North Sea offshore Norway and Scotland, and in an area offshore Newfoundland where energy operators must contend with floating icebergs. Recently, GBS's are being proposed for the storage of LNG.

LNG is natural gas cooled to cryogenic temperatures (−161 C (−256 F)) through liquefaction, and is transported and stored in its liquid state. Since LNG has never before been stored in a GBS, dealing with LNG spills in a GBS environment is a new issue.

U.S. Pat. No. 3,657,895 discloses a platform for offshore wells for which a curbing around the periphery of the platform contains oil spills onto the deck platform, and the deck of the platform slopes downwardly from the curbing to an opening in the platform surrounding the well.

U.S. Pat. No. 3,675,431 discloses an off-shore storage tank for liquefied gas. The tank has an outer shell of which at least the lower part, which is immersed in the water, is made of solid concrete, and does not include a sump.

U.S. Pat. No. 3,727,418 discloses a sub-aqueous storage of liquefied natural gas. The patent discloses a submerged, jacketed container having an interior which is coupled to a balancing fluid in another container. The balancing fluid is coupled to the water surrounding both containers.

U.S. Pat. No. 3,984,059 discloses a marine loading system for liquefied natural gas handling. Various plants sites in the system are connected by coaxial ducting. There is no disclosure of a sump.

U.S. Pat. No. 4,188,157 discloses an offshore structure handling cryogenic fluids such as liquefied natural gas. The structure includes a cell-matrix. The patent does not disclose an LNG sump.

U.S. Pat. No. 4,202,648 discloses a floating plant for offshore liquefaction, temporary storage, and loading of liquefied natural gas. The plant includes a semi-submersible platform with storage tanks for LNG arranged in the submerged section of the platform. The patent does not disclose an LNG sump.

U.S. Pat. No. 4,209,267 discloses an improvement in storage systems for liquefied natural gas, to provide increased security in cases of tank rupture. The safety system includes a dike, impounding wall or drainage channel constructed of compacted earth, concrete, metal and/or other suitable substance, surrounding an aboveground steel insulated tank used to store the liquefied gas. A drop shaft is used to communicate the diked area with an underground tunnel for temporary accumulation and subsequent safe disposal of liquid which has escaped from the storage tank. Inert gas is used to neutralize the hazards of a spill, and stored liquid is pumped to a storage tank.

U.S. Pat. No. 4,217,848 discloses a floating gas liquefaction installation having a liquefaction unit and a sealed, thermally insulated tank space. The patent does not disclose of an LNG sump.

U.S. Pat. No. 4,302,130 discloses an offshore platform with storage facilities for natural gas. This patent also does not disclose of an LNG sump.

U.S. Pat. No. 4,365,576 discloses improvements in an offshore platform and submarine storage facility for highly chilled liquefied gas. This patent also does not disclose of an LNG sump.

U.S. Pat. No. 4,404,988 discloses an apparatus for draining a liquid which has been inadvertently freed from a primary storage container and captured in a containment space. A pump delivers spilled liquid to a remote location.

Thus, there is a need for systems and methods for handling LNG spills when LNG is stored in a GBS.

### SUMMARY OF THE INVENTION

The present invention is directed to an LNG sump that provides containment for an LNG spill on an offshore GBS or other offshore installation.

According to an embodiment of the present invention, a sump includes a preferably long, relatively narrow cylindrical structure that provides sufficient LNG spill containment while minimizing the rate of evolution of gaseous methane at the surface due to the relatively small surface area. The cylinder can be insulated and is preferably arranged to fit neatly into a GBS compartment. Spills from a loading platform can enter the sump area through a trough through the GBS wall.

The LNG sump may require insulation and/or heat tracing to protect the GBS walls from low temperature during a spill event. The LNG sump may be supported by GBS floor sitting on insulation blocks. A cryogenic sump pump maybe installed in the sump to remove rainwater or the like. Spilled LNG will be allowed to boil-off within the sump.

According to an embodiment of the present invention, an LNG sump is provided for a GBS. The LNG sump includes a sump containment structure having a predetermined volume and floor surface area. The volume and floor surface area are selected in order to allow spilled LNG contained within the sump containment structure to vaporize at a predetermined, safe rate. A trough is provided for collecting spilled LNG on the GBS, such as at the processing area and on a jetty, and delivering the spilled LNG to the sump containment structure.

According to an embodiment of the present invention, an LNG sump for a gravity based structure (GBS) includes containment means for collecting spilled LNG and for allowing the spilled LNG contained to vaporize at a predetermined rate. Collecting means is also provided for collecting spilled LNG on the GBS and delivering the spilled LNG to said containment means.

According to an embodiment of the present invention, a method for handling LNG spills on a GBS includes a step of collecting spilled LNG and delivering the spilled LNG to a containment means, and a step of allowing the spilled LNG contained to vaporize at a predetermined rate.

Further applications and advantages of various embodiments of the present invention are discussed below with reference to the drawing figures.

### BRIEF DESCRIPTION OF THE DRAWINGS

FIG. 1 is a diagram of an LNG sump according to an embodiment of the present invention.

FIG. 2 is a perspective view showing installation of a LNG sump in an offshore GBS in accordance with an embodiment of the invention.

FIG. 3 is second perspective view showing installation of the LNG sump according to an embodiment of the invention.

FIG. 4 is a top plan view showing installation of the LNG sump according to an embodiment of the invention.

### DETAILED DESCRIPTION OF THE PREFERRED EMBODIMENTS

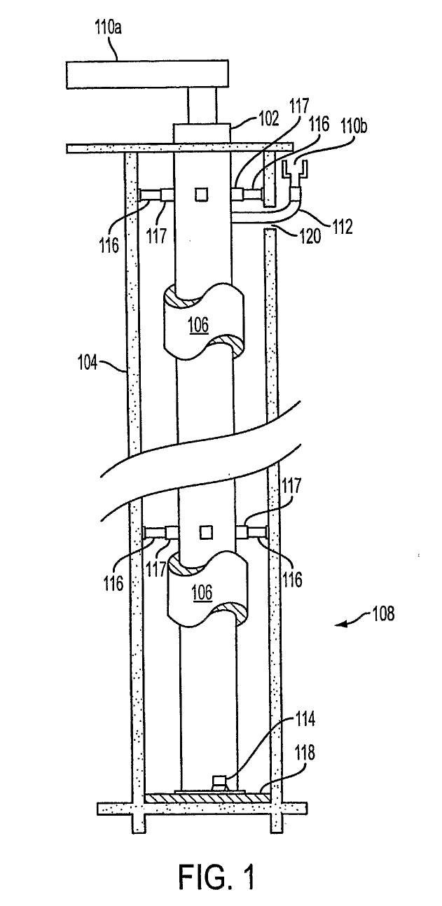

As shown in FIG. 1, an LNG sump 102 has a long relatively narrow cylindrical shape, which has the effect of providing sufficient LNG spill containment while minimizing the rate of evolution of gaseous methane at the surface due to the relatively small surface area. The cylinder may be insulated (106, not shown as completely covering sump) and should fit neatly into a GBS compartment 104. Electrical heat tracing, such provided by a heat blanket 108, can be provided on the outside of the LNG sump 102 and used to protect the surrounding concrete from cryogenic temperatures while allowing some control over the rate of vapor evolution. The electrical tracing or heat blanket fitted outside of the insulation.

A trough 110a collects spilled LNG from the process area and delivers it to the LNG sump 102. A second trough 110b can be used to collect spilled LNG from a jetty or the like, and delivers the spilled LNG to the LNG sump 102 via separate inlet 112 through a slot 120 in the GBS wall. Consideration may be given to the expansion and contraction of the pipes due to chilling and warming.

A sump pump 114 may be provided in the bottom of the sump 102 for removing water and other liquid. Guides 116 can be provided for supporting the sump 102 inside compartment 104. Guides 116 can be insulated with insulation blocks 117 where it contacts sump 102. An insulation block 118 can be provided at the bottom of the LNG sump 102.

In the event of a spill, LNG is collected by gravity in the LNG sump 102 via the troughs 110a, b provided about the GBS where spills may occur. Since the surface area in the bottom of the LNG sump 102 is small, LNG can be allowed to vaporize at a calculated rate that is safe and acceptable to operators. As shown, the exemplary LNG sump 102 is a cylinder more than 30 meters in height with only a 3 meter diameter.

Further, the LNG vaporization rate can be adjusted by adjustment means—it may be reduced by use of foam insulation or increased by use of the electrical/heat tracing on the LNG sump 102 outer walls. Insulation and heat tracing may be used together. The concrete GBS compartment 104 is prevented from reaching cryogenic temperatures by the use of the insulation and/or heat tracing.

Since LNG has never before been stored in a GBS, dealing with spills in this environment has never before been an issue. The inventive geometry of the present invention avoids the large footprint required by deck mounted sumps. Further, the fact that it is mounted within the GBS avoids wave action on the LNG sump 102. The present invention may include other LNG spill containers such as deck-mounted sumps, outboard mounted sumps, etc.

The LNG sump preferable includes, but is not limited to, a long thin cylindrical containment structure extending into the GBS compartment. A single LNG spill sump is preferred for the GBS. One skilled in the art will understand that volume (due to spill size) and location (due to elevation) can be controlled by the loading platform (jetty) area spill. Preferably, volume of the sump 102 should be in range of 200 to 220 cubic meters, and the area of the open top should be minimized.

One skilled in the art will understand that the sump may not need to be insulated for process reasons. For example, during a spill event the exterior of the sump 102 can ice up and be self insulating to an extent.

The LNG sump 102 may be constructed of suitable materials for handling cryogenic temperatures, such as, but not limited to, concrete and aluminum. Aluminum may be preferred due to its low weight and compatibility with the cryogenic temperatures.

The LNG sump 102 may be located exterior to the GBS. An exterior location requires a portion of the sump to be below sea level. Support, wave loading, and fatigue will need to be considered. The sump is preferably located as close as possible to the GBS to minimize support requirements. In the unlikely event that the LNG sump 102 ruptures, rapid phase transition (RPT) loads may occur. One skilled in the art should consider a rupture when locating the sump.

The location within the GBS (in an exterior compartment) is preferred. This location makes the LNG sump 102 easier to support. Spills from the loading platform will enter the LNG sump 102 area via a trough 110a through the GBS wall. The LNG sump 102 may require insulation and heat tracing to protect the GBS walls 104 from low temperatures during a spill event. The LNG sump 102 may be supported by GBS floor sitting on insulation blocks 118.

The diameter (surface area) of the LNG sump is based on the volume requirement, the fixed elevation of the GBS floor and fixed elevation of the loading platform. A cryogenic sump pump 114 may be installed in the LNG sump 102 to remove rainwater or the like. As described above, spilled LNG will be allowed to boil off.

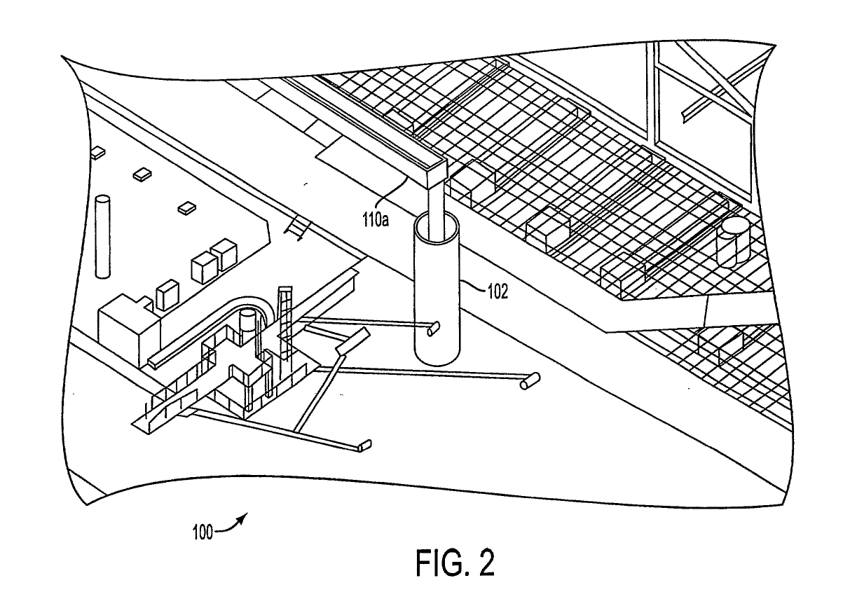

FIG. 2 is a perspective view showing installation of a LNG sump 102 in an offshore GBS 100, in accordance with an embodiment of the invention. As shown, a trough 110a feeds the sump 102.

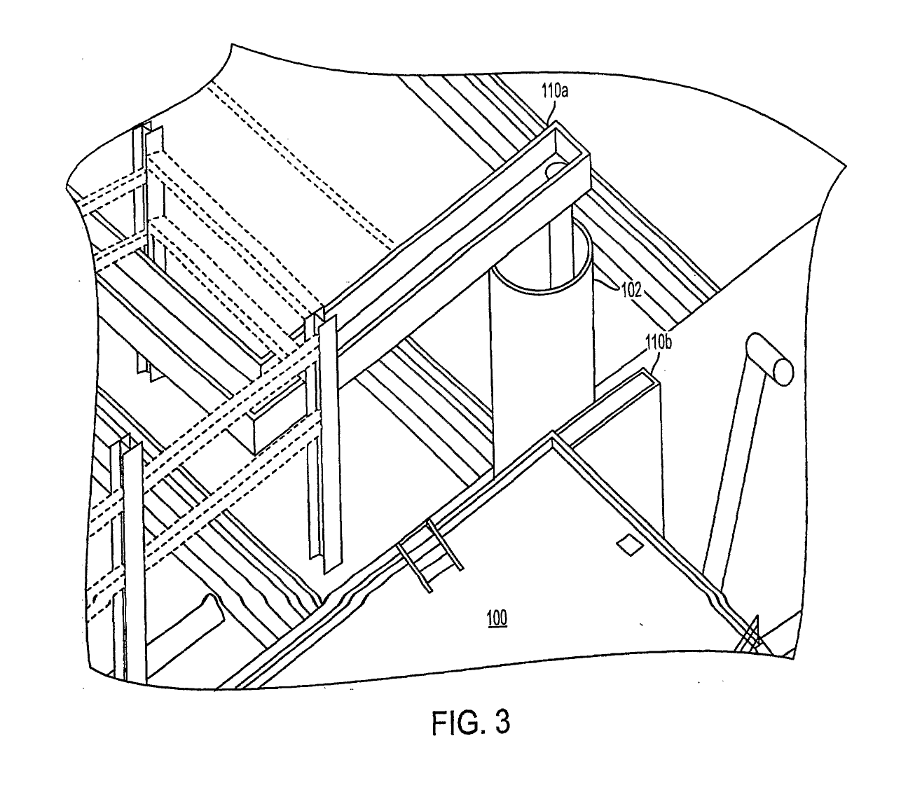

FIG. 3 is second perspective view showing installation of the sump according to an embodiment of the invention. From this view, both troughs 110a, b can be seen.

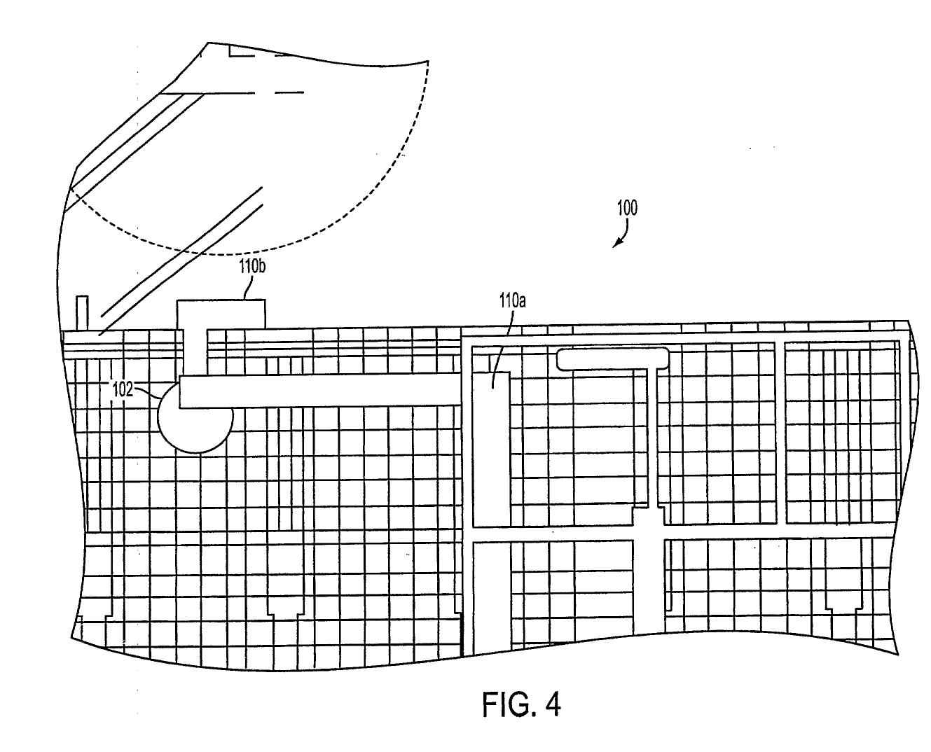

FIG. 4 is a top plan view showing installation of the sump according to an embodiment of the invention.

Thus, a number of preferred embodiments have been fully described above with reference to the drawing figures. Although the invention has been described based upon these preferred embodiments, it would be apparent to those of skilled in the art that certain modifications, variations, and alternative constructions would be apparent, while remaining within the spirit and scope of the invention.

We claim:

1. A liquefied natural gas (LNG) sump for a gravity based structure (GBS), said sump comprising:
a sump containment structure having a predetermined volume and bottom surface area, said volume and bottom surface area being selected in order to allow spilled LNG contained within said sump containment structure to vaporize at a predetermined rate; and
a trough for collecting spilled LNG on said GBS and delivering said spilled LNG to said sump containment structure.

2. The LNG sump as recited in claim 1, wherein said sump containment structure comprises a cylinder having a diameter that is substantially smaller than a height of the cylinder.

3. The LNG sump as recited in claim 1, wherein said sump containment structure is disposed inside a concrete compartment within said GBS.

4. The LNG sump as recited in claim 1, wherein said sump containment structure is insulated.

5. The LNG sump as recited in claim 1, wherein heat tracing is provided on said sump containment structure for controlling the vaporization rate of spilled LNG.

6. The LNG sump as recited in claim 1, further comprising a cryogenic sump pump disposed on a bottom surface of said sump for removing water from said sump.

7. The LNG sump as recited in claim 2, wherein the height of said sump containment structure is at least 10 times greater than the diameter of said sump containment structure.

8. The LNG sump as recited in claim 1, wherein said sump containment structure comprises aluminum.

9. The LNG sump as recited in claim 1, wherein said sump containment structure comprises concrete.

10. The LNG sump as recited in claim 1, wherein said sump containment structure comprises a material resistant to cryogenic temperatures.

11. A liquefied natural gas (LNG) sump for a gravity based structure (GBS), said sump comprising:
containment means for collecting spilled LNG and for allowing the spilled LNG contained to vaporize at a predetermined rate; and
collecting means for collecting spilled LNG on said GBS and delivering said spilled LNG to said containment means.

12. The LNG sump as recited in claim 11, wherein said containment means comprises a cylinder having a diameter that is substantially smaller than a height of the cylinder.

13. The LNG sump as recited in claim 11, wherein said containment means is disposed inside a concrete compartment within said GBS.

14. The LNG sump as recited in claim 11, wherein said containment means is insulated.

15. The LNG sump as recited in claim 11, further comprising means for adjusting the vaporization rate of spilled LNG within said containment means.

16. The LNG sump as recited in claim 11, further comprising means for removing water from said sump.

17. The LNG sump as recited in claim 12, wherein the height of said containment means is at least 10 times greater than the diameter of said sump containment structure.

18. The LNG sump as recited in claim 11, wherein said containment means comprises aluminum outer walls.

19. The LNG sump as recited in claim 11, wherein said containment means comprises concrete outer walls.

20. The LNG sump as recited in claim 11, wherein said containment means is constructed from a material resistant to cryogenic temperatures.

21. A method for handling liquefied natural gas (LNG) spills on a gravity based structure (GBS), said method comprising:
a step of collecting spilled LNG and delivering said spilled LNG to a containment means; and
a step of allowing the spilled LNG contained to vaporize at a predetermined rate.

22. The method as recited in claim 21, wherein said containment means comprises a cylinder having a diameter that is substantially smaller than a height of the cylinder.

23. The method as recited in claim 21, wherein said s containment means is disposed inside a concrete compartment within said GBS.

24. The method as recited in claim 21, wherein said containment means is insulated.

25. The method as recited in claim 21, further comprising a step of adjusting the vaporization rate of spilled LNG within said containment means by proving at least one of insulation and heat tracing on said containment means.

26. The method as recited in claim 21, further comprising a step of removing water from said containment means.

27. The method as recited in claim 22, wherein the height of said containment means is at least 10 times greater than the diameter of said sump containment structure.

28. The method as recited in claim 21, wherein said containment means comprises aluminum outer walls.

29. The method as recited in claim 21, wherein said containment means comprises concrete outer walls.

30. The method as recited in claim 21, wherein said containment means is constructed from a material resistant to cryogenic temperatures.
